(19) United States
(12) Patent Application Publication
(10) Pub. No.: US 2024/0291134 A1
(43) Pub. Date: Aug. 29, 2024

(54) INTRA-CHIP AND INTER-CHIP WIRELESS COMMUNICATIONS

(71) Applicant: Micron Technology, Inc., Boise, ID (US)

(72) Inventors: Fa-Long Luo, San Jose, CA (US); Jaime Cummins, Bainbridge Island, WA (US)

(73) Assignee: Micron Technology, Inc., Boise, ID (US)

(21) Appl. No.: 18/584,915

(22) Filed: Feb. 22, 2024

Related U.S. Application Data
(60) Provisional application No. 63/487,563, filed on Feb. 28, 2023.

(51) Int. Cl. H01Q 1/22; G06F 13/42; H04W 76/16

(52) U.S. Cl. CPC H01Q 1/2283; G06F 13/42; H04W 76/16

(57) ABSTRACT

Examples described herein include an apparatus that includes a device having a first semiconductor chip and a second semiconductor chip. The first semiconductor chip has a configurable baseband processor that is configured to mix input data with a first set of weight values corresponding to a first wireless protocol to be utilized in a wireless, RF transmission to the second semiconductor chip when the input data is a first type of data and to mix the input data with a second set and to mix the input data with a second set of weight values corresponding to a second wireless protocol to be utilized in the wireless, RF transmission to the second semiconductor chip when the input data is a second type of data.

### CROSS REFERENCE TO RELATED APPLICATION(S)

This application claims the under 35 U.S.C. § 119 of the earlier filing date of U.S. Provisional Application Ser. No. 63/487,563 filed Feb. 28, 2023, the entire contents of which are hereby incorporated by reference in their entirety for any purpose.

### BACKGROUND

Conventional implementations for communication within (intra-chip) and between (inter-chip) semiconductor chips include use of physical interconnections, which tend to drive layout and placement of circuitry in a semiconductor device. These limitations can also drive up costs and consume considerable portions of a layout. Use of wireless solutions in inter- and intra-chip communications have historically been insufficient from a bandwidth, latency, and processing complexity perspective when compared with physical interconnections. With the constant push toward higher throughput, and faster communications on smaller packages, inter- and intra-chip communication solutions that include wireless communications may prove helpful to moving the technology forward. Moreover, there is interest in moving wireless communications to “sixth generation” (6G) systems. 6G offers promise of increased speed and ubiquity, but methodologies for processing 6G wireless communications have not yet been set, so there is a desire that new architectures are adaptable to future communication standards.

### BRIEF DESCRIPTION OF THE DRAWINGS

FIG. 1 is a schematic illustration of a computing system in accordance with examples described herein.

FIG. 2 is a schematic illustration of a computing system in accordance with examples described herein.

FIGS. 3A and 3B are schematic illustrations of a wireless transceiver in accordance with examples described herein.

FIG. 4 is a schematic illustration of a processing unit arranged in a system in accordance with examples described herein.

FIG. 5 is a schematic illustration of a computing system in accordance with examples described herein.

FIG. 6 is a flowchart of a method in accordance with examples described herein.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known wireless communication components, circuits, control signals, timing protocols, computing system components, and software operations have not been shown in detail in order to avoid unnecessarily obscuring the described embodiments of the invention.

This disclosure describes examples of a single processing architecture that is capable of performing multiple tasks of baseband (digital) processing for enabling Terahertz (or other frequency) intra-chip and inter-chip data transmissions in one device by simply changing/reconfiguring the parameters (e.g., weights of a multiplayer neural network architecture). In other words, the proposed single processing architecture solution can replace all baseband (digital) processing units for enabling Terahertz intra-linter chip data transmissions in one device. In addition, the proposed will also enable future changes and adding for new intra/inter connections without any hardware modifications of baseband processing.

Since the use of Terahertz frequency spectrum could deliver terabit per second (Tbps) wireless data transmission, optical or electronic interconnections among intra-chips and inter-chips (e.g., processor to processor, processor to memory, chip to chip, etc.) may be replaced by the Terahertz based wireless connections. However, one of the biggest challenges to bring this technology to real practice is that various different processing architectures are needed in one chip or one device so as to meet different requirements of transmission bandwidths, latency and costs for intra-chips and inter-chips connections. This is mainly because it is not likely that one single modulation and coding algorithm could meet all these requirements. For example, simple on-off keying (OOK) or pulse amplitude modulation (PAM) or constrained pulse phase-shift key (PSK) modulation could be used for some low bandwidth connections, but a complex quadrature amplitude modulation (QAM) or index modulation may be preferable for other higher bandwidths connections. Each modulation scheme needs its own processing unit in hardware implementation. Also, different modulation schemes make the other baseband (digital) processing parts be different in terms of the waveform generation, coding and filtering. This suggests that multiple different baseband processing architectures may be necessary in order for Terahertz connection to replace all the existing electronic and optical connections in one chip or device. To mitigate the complexity and cost of implementing different processing architecture offsetting the desired advantage of Terahertz based solution, a single processing architecture that can perform some or all the tasks of baseband (e.g., digital) processing by changing/reconfiguring the parameters. For example, the single processing architecture may include a neural network architecture that includes weights that can be configured for each different type of baseband processing task.

There is interest in moving wireless communications to “sixth generation” (6G) systems. 6G offers promise of increased speed and ubiquity, but methodologies for processing 6G wireless communications have not yet been set. The lead time in designing and processing a hardware platform for wireless communications can be significant. Accordingly, it may be advantageous in some examples to design and/or process a hardware platform for 6G wireless communication that may process wireless communications using a configurable algorithm, with the benefit that algorithm utilized by the hardware platform may not need to be decided until after the platform is designed and/or fabricated.

Examples described herein include systems and methods which include wireless devices and systems with examples of mixing input data with weight data. The input data may be any data that is input for digital signal processing. The weight data may be any data that is specific to a wireless protocol. Examples of wireless protocols include, but are not limited to a advanced wireless system utilizing a wireless protocol such as filter bank multi-carrier (FBMC), the generalized frequency division multiplexing (GFDM), universal filtered multi-carrier (UFMC) transmission, bi-orthogonal frequency division multiplexing (BFDM), sparse code multiple access (SCMA), non-orthogonal multiple access (NOMA), multi-user shared access (MUSA) and faster-than-Nyquist (FTN) signaling with time-frequency packing. Generally, any wireless protocol including any wireless protocol may be represented by weight data as disclosed herein. The input data may be mixed with the weight data to generate output data. For example, a computing system with processing units may mix the input data for a transmission in a radio frequency (RF) wireless domain with the weight data to generate output data that is representative of the transmission being processed according to the wireless protocol in the RF wireless domain. In some examples, the computing system generates an approximation of output data. For example, the output data may be an approximation of output data generated when input data is processed in hardware (e.g., an FPGA) specifically-designed to implement the wireless protocol that the weights correspond to.

While the above example of mixing input data with weight data has described in terms of an RF wireless domain, it can be appreciated that wireless communication data may be processed from the perspective of different domains, such as a time domain (e.g., time-division multiple access (TDMA)), a frequency domain (e.g., orthogonal frequency-division multiple access (OFDMA), and/or a code domain (e.g., code-division multiple access (CDMA)).

Advantageously in some examples, the systems and methods described herein may operate according to multiple standards and/or with multiple applications, including changes or upgrades to each thereto; in contrast to the inflexible framework of an ASIC-based solution. In some examples, as discussed herein in terms of processing units implementing multiplication, addition, or accumulation functionalities, examples of the systems and methods described herein may operate on a power-efficient framework, consuming minimal power with such functionalities; in contrast to a power-hungry framework of a FPGA/DSP-based solution. In some examples, systems and methods described herein may operate with a substantially integrated framework from a unified programming language perspective; in contrast to the various programming languages needed for integration of a SoC solution that may can pose programming challenges when implementing heterogeneous interfaces for control units, computational units, data units and accelerator units.

In some examples, the processing architecture may receive a baseband processing mode selection, for example, a baseband processing mode selection from a process for communication with another device within the computing system or device. A baseband processing mode selection can indicate a specific baseband processing mode for the device.

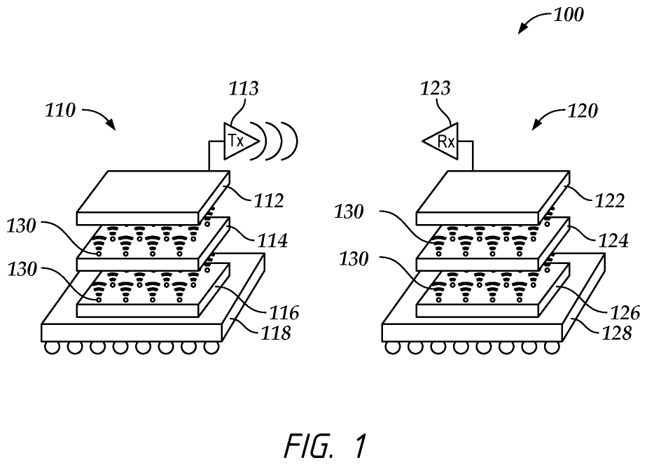

FIG. 1 is a schematic illustration of a computing system 100 in accordance with examples described herein. The computing system 100 may include a semiconductor device 110 and a semiconductor device 120. The semiconductor device 110 may include chips 112, 114, 116 on a substrate 118. The semiconductor device 120 may include chips 122, 124, 126 on a substrate 128. Each of the semiconductor device 110 and the semiconductor device 120 may form a system on a chip (SoC), a module, a chip stack, or any combination thereof, etc.

Within the semiconductor device 110, communication between the chips 112, 114, 116 (e.g., intra-device communication) may be performed using one or more wireless communication protocols via wireless channels 130. Each of the chips 112, 114, 116 may include a single processing architecture that can perform some or all the tasks of baseband (e.g., digital) processing by changing/reconfiguring the parameters to communicate using a selected one of the one or more wireless communication protocols. In some examples, the one or more wireless communication protocols may include wireless communication protocols using a TeraHertz channel. In some examples, each of the chips 112, 114, 116 may include at least one neural network architecture that includes adjustable weights to be configured for each different type of baseband processing task. For example, the weights for the neural network architecture may be set to a first configuration to implement simple on-off keying (OOK) or pulse amplitude modulation (PAM) or constrained pulse phase-shift key (PSK) modulation for some low bandwidth connections, and may be set to a second configuration to implement a complex quadrature amplitude modulation (QAM) or index modulation for higher bandwidths connections. The neural network architecture may abstract out some or all elements of baseband processing to achieve the single baseband processing architecture for use in various different applications and protocols. Within the semiconductor device 120, communication between the chips 122, 124, 126 (e.g., intra-device communication) may be performed using one or more wireless communication protocols via wireless channels 130 in the same manner as described with reference to the semiconductor device 110.

In addition, communication between the semiconductor device 110 and the semiconductor device 120 may be performed using one or more wireless communication protocols via wireless channels using the antenna 113 and the antenna 123. While FIG. 1 depicts the semiconductor device 110 with the antenna 113 and the semiconductor device 120 with the antenna 123, it is appreciated that the semiconductor device 120 may also include a transmitter and the semiconductor device 110 may also include a receiver to perform inter-chip communications. Each of the antenna 113 and the antenna 123 may include a single processing architecture that can perform some or all the tasks of baseband (e.g., digital) processing by changing/reconfiguring the parameters to communicate using a selected one of the one or more wireless communication protocols. In some examples, the one or more wireless communication protocols may include wireless communication protocols using a TeraHertz channel. In some examples, each of the semiconductor device 110 and the semiconductor device 120 may include at least one neural network architecture that includes adjustable weights to be configured for each different type of baseband processing task. For example, the weights for the neural network architecture may be set to a first configuration to implement a first communication protocol, and may be set to a second configuration to implement a second communication protocol. This single processing architecture may reduce cost and complexity as compared with having to implement difference processing architectures for each type of wireless communication protocol. The configurable nature of the single processing architecture may also provide support for advanced wireless communication protocols (e.g., 5G, 6G, and beyond).

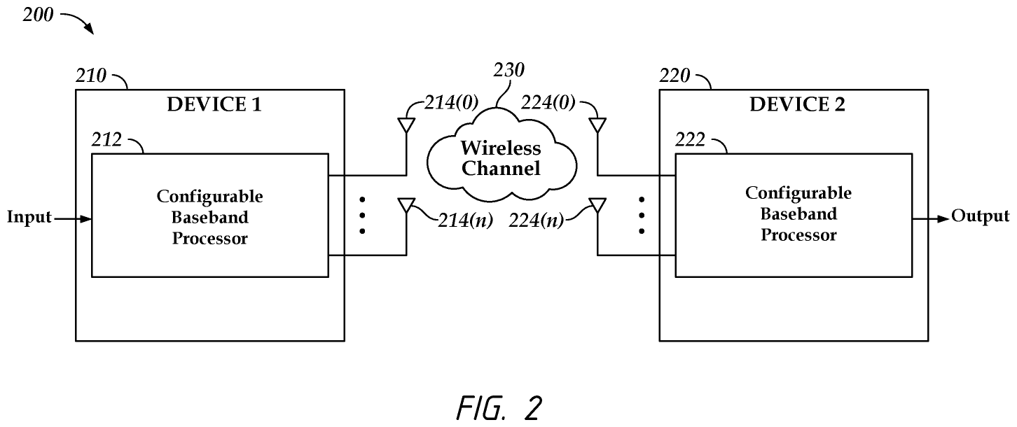

FIG. 2 is a schematic illustration of a computing system 200 in accordance with examples described herein. The computing system 100 of FIG. 1 may implement the computing system 200, in some examples. The computing system 200 may include a semiconductor chip 210 configured to wirelessly communicate with a semiconductor chip 220 via a 230. Each of the semiconductor chip 210 and the semiconductor chip 220 may include a single chip and together form a single module or system, in some examples. In some examples, each of the semiconductor chip 210 and the semiconductor chip 220 may include a system of one or more chips. Each of the semiconductor chip 210 and the semiconductor chip 220 may form a system on a chip (SoC), a module, a chip stack, or any combination thereof, etc.

The semiconductor chip 210 may include multiple antenna 214(0)-(n) to form a multiple input, multiple output (MIMO) architecture or a massive MIMO architecture for communication over the 230. Similarly, the semiconductor chip 220 may include multiple antenna 224(0)-(n) to form a multiple input, multiple output (MIMO) architecture or a massive MIMO architecture for communication over the 230.

The semiconductor chip 210 may include a configurable baseband processor 212 and the semiconductor chip 220 may include a configurable baseband processor 222 that can each perform some or all the tasks of baseband (e.g., digital) processing by changing/reconfiguring the parameters to communicate using a selected one of the one or more wireless communication protocols. In some examples, the one or more wireless communication protocols may include wireless communication protocols using a TeraHertz channel. In some examples, the configurable baseband processor 212 and the configurable baseband processor 222 may each include at least one neural network architecture that includes adjustable weights to be configured for each different type of baseband processing task. For example, the weights for the neural network architecture of the configurable baseband processor 212 and/or the configurable baseband processor 222 may be set to a first configuration to implement a first communication protocol (e.g., for low bandwidth connections), and may be set to a second configuration to implement a second communication protocol (e.g., for higher bandwidths connections). As shown, the configurable baseband processor 212 of the semiconductor chip 210 may receive input data to be transmitted to the semiconductor chip 220 via the 230. The configurable baseband processor 212 may be configured to perform baseband processing of the input data based on a configuration of weights to transmit the input data from one or more of the antenna 214(0)-(n) to the antenna 224(0)-(n) of the semiconductor chip 220 via the 230. The configurable baseband processor 222 of the semiconductor chip 220 may be configured to receive the transmission from the semiconductor chip 210 and to perform baseband processing of the received transmission based on a configuration of weights to decode the transmitted data to retrieve output data, which can be passed along for further consumption, processing, storage, etc.

The neural network architecture of the configurable baseband processor 212 and the configurable baseband processor 222 may abstract out some or all elements of baseband processing to achieve the single baseband processing architecture for use in various different applications and protocols. The configurable nature of the configurable baseband processor 212 and the configurable baseband processor 222 may also provide support for advanced wireless communication protocols (e.g., 5G, 6G, and beyond). While the semiconductor chip 210 and the semiconductor chip 220 of FIG. 2 only show the configurable baseband processor 212 and the configurable baseband processor 222, it is appreciated that the semiconductor chip 210 and the semiconductor chip 220 may include one or more other processor units, one or more memories, other circuitry, etc., that are configured to perform various tasks related to use of the semiconductor chip 210 and the semiconductor chip 220. Those elements have been eliminated for brevity and clarity.

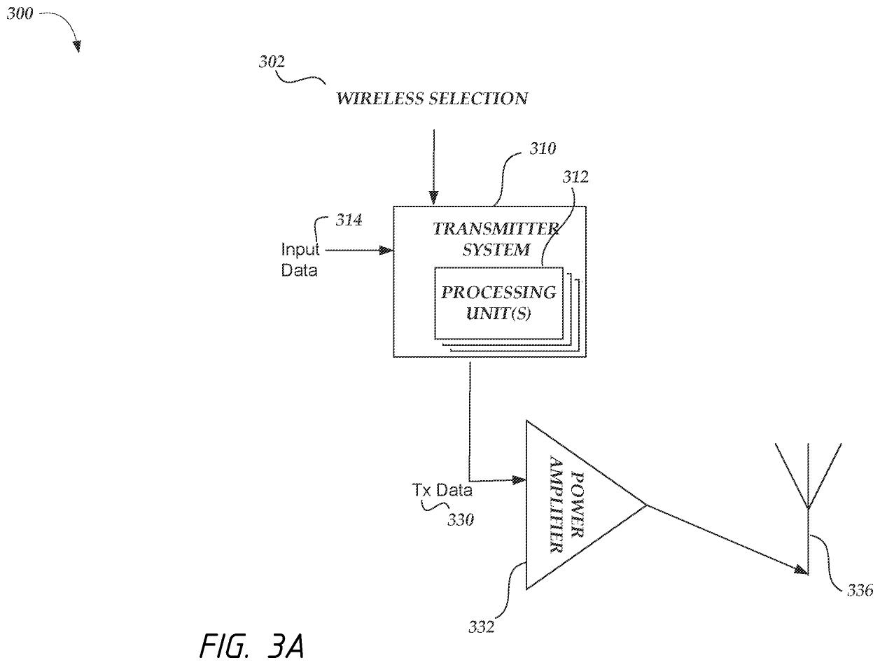

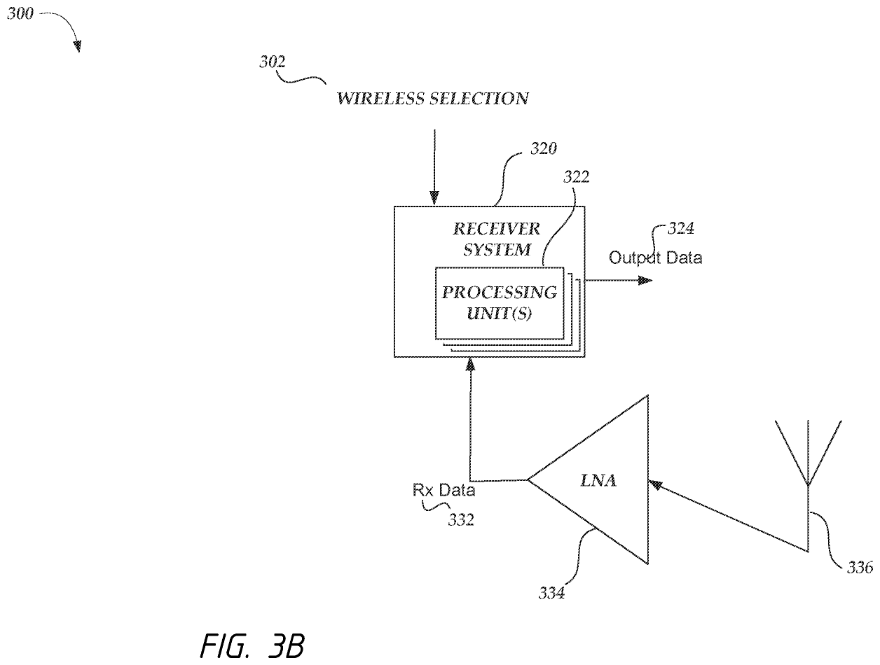

FIGS. 3A and 3B are schematic illustrations of a wireless transceiver 300 in accordance with examples described herein. In some examples, chips of the semiconductor device 110 and/or the semiconductor device 120 of FIG. 1 and/or the semiconductor chip 210 and/or the semiconductor chip 220 of FIG. 2 may implement the wireless transceiver 300 in some examples. The wireless transceiver 300 may perform several operations of an RF-front end for a wireless transmission with input data 314 and for wireless reception of output data 324.

With reference to FIG. 3A, the wireless transceiver 300 may include a transmitter system 310 that utilizes one or more processing units 312 to perform the operations of an RF-front end. The one or more processing units 312 may execute instructions that perform baseband processing by mixing the input data 314 with weight data selected based on a desired communication protocol selected via the wireless selection. The mixed input data 314 with the weights may generate transmit Tx data, which may be an input to power amplifier 332. For example, the input data 314 may be multiplied with the weight data to generate a multiplication result at multiplication unit/accumulation unit, and the multiplication result may be accumulated at that multiplication unit/accumulation unit to be further multiplied and accumulated with other portions of the input data and additional weights of the plurality of weights. For example, the one or more processing units 312 may utilize a configuration of weights set via the wireless selection to generate Tx data for transmission via the antenna 336 using a prescribed communication protocol. The antenna 336 may be an antenna designed to transmit at a specific radio frequency (e.g., a Terahertz frequency), in some examples.

In some examples, one or more processing units 312 may include at least one neural network architecture that includes adjustable weights to be configured for each different type of baseband processing task. For example, the weights for the neural network architecture of the one or more processing units 312 may be set to a first configuration to implement a first communication protocol (e.g., for low bandwidth connections), and may be set to a second configuration to implement a second communication protocol (e.g., for higher bandwidths connections).

The weight data selected via the wireless selection may be retrieved from a memory of the transmitter system 310. The weights retrieved from the memory may be specific to the particular selected communication protocol. The neural network architecture of the one or more processing units 312 may abstract out some or all elements of baseband processing to achieve the single baseband processing architecture for use in various different applications and protocols. The configurable nature of the one or more processing units 312 may also provide support for advanced wireless communication protocols (e.g., 5G, 6G, and beyond).

With reference to FIG. 3B, the wireless transceiver 300 may further include a 320 with a low-noise amplifier (LNA) configured to receive RF signals and to provide receive Rx data from the antenna 336 and a receiver system 320 to generate output data based on the Rx data. The 320 may perform operations of the wireless transceiver 300 using one or more processor units 322 to decode the Rx data encoded using a specified communication protocol.

The one or more processing units 322 may execute instructions that perform baseband processing by mixing the Rx data 332 with weight data selected according to a selected communication protocol selected via the wireless selection. The mixed Rx data 332 with the weights may generate output data. For example, the Rx data 332 may be multiplied with the weight data to generate a multiplication result at multiplication unit/accumulation unit, and the multiplication result may be accumulated at that multiplication unit/accumulation unit to be further multiplied and accumulated with other portions of the Rx data and additional weights of the plurality of weights. For example, the one or more processing units 322 may utilize a configuration of weights set via the wireless selection to generate the output data.

In some examples, the one or more processing units 322 may include at least one neural network architecture that includes adjustable weights to be configured for each different type of baseband processing task. For example, the weights for the neural network architecture of the one or more processing units 322 may be set to a first configuration to implement a first communication protocol (e.g., for low bandwidth connections), and may be set to a second configuration to implement a second communication protocol (e.g., for higher bandwidths connections).

The weight data selected via the wireless selection may be retrieved from a memory of the receiver system 320. The weights retrieved from the memory may be specific to the particular selected communication protocol. The neural network architecture of the one or more processing units 322 may abstract out some or all elements of baseband processing to achieve the single baseband processing architecture for use in various different applications and protocols. The configurable nature of the one or more processing units 322 may also provide support for advanced wireless communication protocols (e.g., 5G, 6G, and beyond).

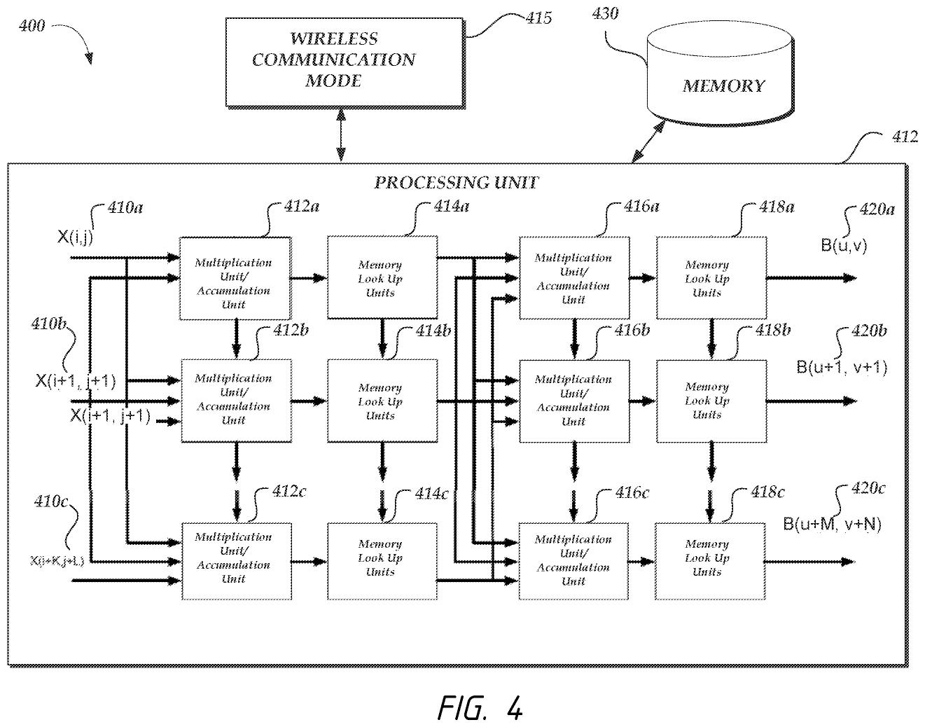

FIG. 4 is a schematic illustration of a processing unit 412 arranged in a system 400 in accordance with examples described herein. The processing unit 412 may receive input data (e.g. X (i,j)) 410a-c, as implemented executing wireless communication mode instructions 415 stored at the memory 430. The processing unit 412 may be implemented in the semiconductor device 110 and/or the semiconductor device 120 of FIG. 1, the configurable baseband processor 212 and/or the configurable baseband processor 222 of FIG. 2, and/or the one or more processing units 312 and/or the one or more processing units 322 of FIGS. 3A and 3B, respectively, in some examples.

The processing unit 412 may include multiplication unit/accumulation units 412a-c, 416a-c and memory look-up units 414a-c, 418a-c that, when wireless communication mode instructions 415 are executed, may generate output data (e.g. B (u,v)) 420a-c. The wireless communication mode instructions 415 may be configured to designate the weight data used by the processing unit 412. The weight data may be selected based on a target wireless communication protocol, and whether the input data is received or transmitted. The multiplication unit/accumulation units 412a-c, 416a-c multiply two operands from the input data 410a-c to generate a multiplication processing result that is accumulated by the accumulation unit portion of the multiplication unit/accumulation units 412a-c, 416a-c. The multiplication unit/accumulation units 412a-c, 416a-c adds the multiplication processing result to update the processing result stored in the accumulation unit portion, thereby accumulating the multiplication processing result. For example, the multiplication unit/accumulation units 412a-c, 416a-c may perform a multiply-accumulate operation such that two operands, A and B, are multiplied and then added with C to generate a new version of C that is stored in its respective multiplication unit/accumulation units. The memory look-up units 414a-c, 418a-c retrieve weight data stored in memory 430. For example, the memory look-up unit can be a table look-up that retrieves a specific weight. The output of the memory look-up units 414a-c, 418a-c is provided to the multiplication unit/accumulation units 412a-c, 416a-c that may be utilized as a multiplication operand in the multiplication unit portion of the multiplication unit/accumulation units 412a-c, 416a-c. In some examples, wireless communication mode instructions 415 may be executed to facilitate selection of a specific processing mode for the processing unit 412. Using such a circuitry arrangement, the output data (e.g. B (u,v)) 420a-c may be generated from the input data (e.g. X (i,j)) 410a-c.

In some examples, weight data, for example from memory 430, can be mixed with the input data X (i,j) 410a-c to generate the output data B (u,v) 420a-c. The relationship of the weight data to the output data B (u,v) 420a-c based on the input data X (i,j) 410a-c may be expressed as:

$$B ( u , v ) f ( {\sum }_{m , n}^{M , N} {a}_{m , n}^{″} f ( {\sum }_{k , l}^{K , L} {a}_{k , l}^{′} X ( i + k , j\_l ) ) ) \qquad ( 1 )$$

where a_{k,l}′, a_{m,n}′ are weights for the first set of multiplication/accumulation units 412a-c and second set of multiplication/accumulation units 416a-c, respectively, and where f(•) stands for the mapping relationship performed by the memory look-up units 414a-c, 418a-c. As described above, the memory look-up units 414a-c, 418a c retrieve weights to mix with the input data. Accordingly, the output data may be provided by manipulating the input data with multiplication/accumulation units using a set of weights stored in the memory associated with a desired wireless protocol. The resulting mapped data may be manipulated by additional multiplication/accumulation units using additional sets of weights stored in the memory associated with the desired wireless protocol. The sets of weights multiplied at each stage of the processing unit 412 may represent or provide an estimation of the processing of the input data according to the wireless protocol in specifically-designed hardware (e.g., an FPGA). Further, it can be shown that the system 400, as represented by Equation 1, may approximate any nonlinear mapping with arbitrarily small error in some examples and the mapping of system 400 is determined by the weights a_{k,l}′, a_{m,n}′. For example, if such weight data is specified, any mapping and processing between the input data X (i,j) 410a-c and the output data B (u,v) 420a-c may be accomplished by the system 400. Such a relationship, as derived from the circuitry arrangement depicted in system 400, may be used to train a computing device to generate weight data. For example, using Equation (1), the computing device may compare input data to the output data to generate the weight data.

In the example of system 400, the processing unit 412 mixes the weight data with the input data X (i,j) 410a-c utilizing the memory look-up units 414a-c, 418a-c. In some examples, the memory look-up units 414a-c, 418a-c can be referred to as table look-up units. The weight data may be associated with a mapping relationship for the input data X (i,j) 410a-c to the output data B (u,v) 420a-c. For example, the weight data may represent non-linear mappings of the input data X (i,j) 410a-c to the output data B (u,v) 420a-c. In some examples, the non-linear mappings of the weight data may represent a Gaussian function, a piece-wise linear function, a sigmoid function, a thin-plate-spline function, a multiquadratic function, a cubic approximation, an inverse multi-quadratic function, or combinations thereof. In some examples, some or all of the memory look-up units 414a-c, 418a-c may be deactivated. For example, one or more of the memory look-up units 414a-c, 418a-c may operate as a gain unit with the unity gain. In such a case, the wireless communication mode instructions 415 may be executed to facilitate selection of a unity gain processing mode for some or all of the memory look up units 414a-c, 418a-c.

In some examples, the wireless communication mode instructions 415 are executed to determine whether some of the weight data is identical. In such a case, the wireless communication mode instructions 415 may be executed to facilitate selection of a single memory look-up unit for identical weights. For example, if the weight data to be retrieved by the memory look-up units 414a and 414b are identical, then a single memory look-up unit 414 could replace the memory look-up units 414a and 414b. Continuing in the example, the wireless communication mode instructions 415 may be further executed to configure memory look-up unit 414a to receive input from both multiplication unit/accumulation unit 412a and multiplication unit/accumulation unit 412b, at different times or at the same time.

Each of the multiplication unit/accumulation units 412a-c, 416a-c may include multiple multipliers, multiple accumulation unit, or and/or multiple adders. Any one of the multiplication unit/accumulation units 412a-c, 416a-c may be implemented using an ALU. In some examples, any one of the multiplication unit/accumulation units 412a-c, 416a-c can include one multiplier and one adder that each perform, respectively, multiple multiplications and multiple additions. The input-output relationship of a multiplication/accumulation unit 412, 416 may be represented as:

$${B}_{out} = {\sum }_{i = 1}^{I} {C}_{i}^{*} {B}_{i n} ( i ) \qquad ( 2 )$$

where “I” represents a number to perform the multiplications in that unit, Cᵢ the weights which may be accessed from a memory, such as weight data memory 430, and Bₘ(i) represents a factor from either the input data X (i,j) 410a-c or an output from multiplication unit/accumulation units 412a-c, 416a-c. In an example, the output of a set of multiplication unit/accumulation units, Bₒᵤₜ, equals the sum of weight data, Cᵢ multiplied by the output of another set of multiplication unit/accumulation units, Bᵢₙ(i). In the example, Bᵢₙ(i) may also be the input data such that the output of a set of multiplication unit/accumulation units, Bₒᵤₜ, equals the sum of weight data, Cᵢ multiplied by input data.

In some examples where the processing unit 412 is implemented to provide data in accordance with a wireless protocol with input data to be transmitted in a transmission according to the wireless protocol, the output data B (u,v) 420a-c may be derived from the inputs of the system 400, in the following manner. The input data X (i,j) 410a-c may be represented as symbols to be modulated and to generate output data B (u,v) 420a-c for a DAC, thereby formatting the output data for transmission by an antenna (e.g., an RF antenna). In some examples, the inputs 410a-c may be expressed as:

$$x ( n ) = {\sum }_{k = 0}^{K - 1} d ( k , m ) {e}^{- j2 π \frac{kn}{N}} \qquad ( 3 )$$

$$x ( n ) = {\sum }_{m = 0}^{M - 1} {\sum }_{k = 0}^{K - 1} d ( k , m ) g [ n ] * δ [ n - mN ] {e}^{- j2 π \frac{kn}{N}} \qquad ( 4 )$$

where n is the time index, k is the sub-carrier index, m is the time-symbol index, M is the number of symbols per sub-carrier, K is the number of active sub-carriers and N is the total number of sub-carriers (e.g., the length of Discrete Fourier Transform (DFT)), x(n) is the input data X (i,j) 410a-c, g[n] are the shaping filter weights and d (k,m) is the coded data related to m'th symbol. In some examples where the system 400 implements OFDM, Equation 3 may be further generalized to:

$$x ( n ) = {\sum }_{k = 0}^{K - 1} d ( k , m ) * {g}_{k} ( n ) \qquad ( 5 )$$

where gk(n) is the impulse response of the k'th filter. Accordingly, a filter with a rectangular impulse response can represent the input data X (i,j) 410a-c. And Equation 5 may also be expressed as:

$$x ( n ) = {\sum }_{b = 0}^{B - 1} {\sum }_{k = 0}^{{K}_{b} - 1} d ( k , m ) * {g}_{k} ( b , n ) \qquad ( 6 )$$

where B is the number of sub-bands, K_{b} is the number of subcarriers in b'th sub-band, gₖ (b, n) is the impulse response of the corresponding k'th filter in b'th sub-band.

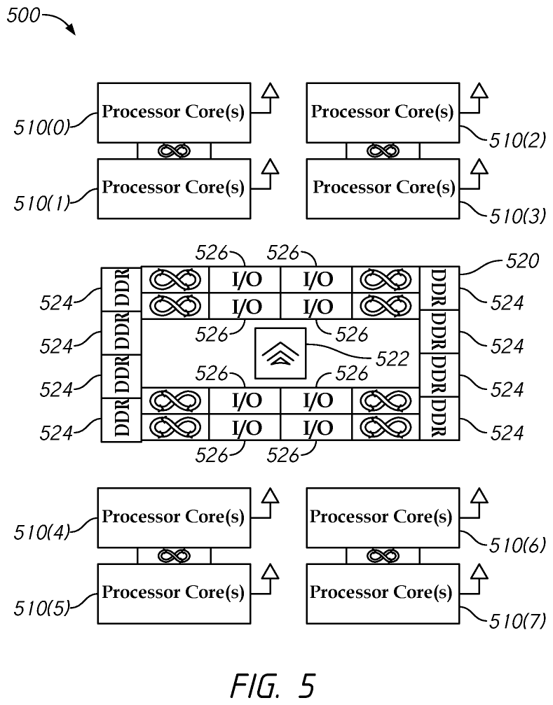

FIG. 5 is a schematic illustration of a computing system 500 in accordance with examples described herein. The computing system 100 of FIG. 1, the computing system 200 of FIG. 2, the wireless transceiver 300 of FIGS. 3A and 3B may implement the computing system 500, in some examples. The system 400 of FIG. 4 may be implemented in the computing system 500. The computing system 500 may include multiple processor cores 510(0)-(7) configured to wirelessly communicate with memory 520. The memory 520 may include a memory controller 522 configured to communicate with multiple double data rate (DDR) memories 524 via input/output channels.

Each of the processor cores 510(0)-(7) may include one or more antenna for communication over a wireless channel with each other or with the memory 520. Similarly, the memory controller 522 and/or each of the DDR memory 524 of the memory 520 may include multiple antenna for communication over a wireless channel with the processor cores 510(0)-(7) or with each other.

The processor cores 510(0)-(7), the memory controller 522, and/or each of the DDR memory 524 may include respective single processor architectures configured to perform some or all the tasks of baseband (e.g., digital) processing by changing/reconfiguring the parameters to communicate using a selected one of the one or more wireless communication protocols. In some examples, the one or more wireless communication protocols may include wireless communication protocols using a TeraHertz channel. In some examples, the respective single processor architecture of each of the processor cores 510(0)-(7), the memory controller 522, and/or the DDR memory 524 may each include at least one neural network architecture that includes adjustable weights to be configured for each different type of baseband processing task. For example, the weights for the neural network architecture of respective single processor architecture of each of the processor cores 510(0)-(7), the memory controller 522, and/or the DDR memory 524 may be set to implement different wireless communication protocols based on the type of communication and the sender and receiver of the communicated information. For example, when two of the processor cores 510(0)-(7) communicate with each other, they may use a different wireless protocol than when communicating with the memory 520. The single processor architecture that is configurable may provide flexibility and reduce hardware complexity as compared with typical solutions that support multiple different types of wireless communication protocols.

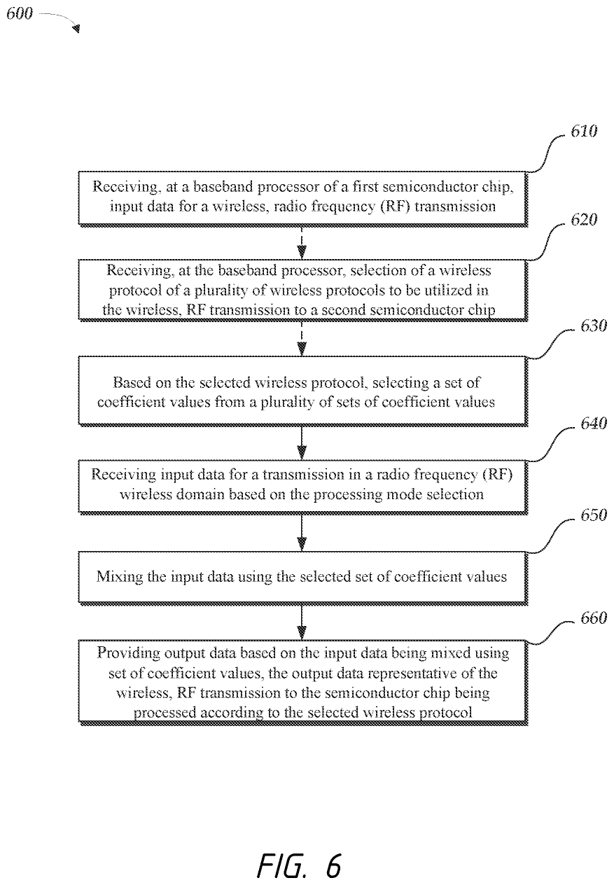

FIG. 6 is a flowchart of a method 600 in accordance with examples described herein. The method 600 may be implemented using, for example, various components of the computing system of FIG. 1, various components of the computing system 200 in FIG. 2, the wireless transceiver of FIGS. 3A and 3B, the processing unit 412 of FIG. 4, or various components of the computing system 500 of FIG. 5.

The method 600 may include receiving, at a baseband processor, input data for a wireless, radio frequency (RF) transmission, at 610. The baseband processor may include a baseband processor of any of the chips 112, 114, 116, 122, 124, 126 of FIG. 1, either of the configurable baseband processor 212 or the configurable baseband processor 222 of FIG. 2, either of the one or more processing units 312 or 322 of FIGS. 3A and 3B, respectively, the processing unit 412 of FIG. 4, and/or the processor cores 510(0)-(7), the memory controller 522, and/or each of the DDR memory 524 of FIG. 5.

The method 600 may further include receiving, at the baseband processor, selection of a wireless protocol of a plurality of wireless protocols to be utilized in the wireless, RF transmission to a semiconductor chip, at 620.

The method 600 may further include based on the selected wireless protocol, selecting a set of weight values from a plurality of sets of weight values, at 630. In some examples, the method 600 may include selecting a first set of weight values from the plurality of sets of weight values as the selected set of weight values in response to the wireless protocol being a first wireless protocol, and selecting a second set of weight values from the plurality of sets of weight values as the selected set of weight values in response to the wireless protocol being a second wireless protocol. In some examples, wherein the first wireless protocol is for intra-device communications and the second wireless protocol is for inter-device communications. In some examples, the first semiconductor chip and the second semiconductor chip are both included in a single semiconductor device (e.g., engaged in intra-device, wireless communications). In some examples, the semiconductor chip and the second semiconductor chip are both included different semiconductor devices (e.g., engaged in inter-device, wireless communications).

The method 600 may further include mixing the input data using the selected set of weight values, at 640.

The method 600 may further include providing output data based on the input data being mixed using set of weight values, at 650. The output data may be representative of the wireless, RF transmission to the semiconductor chip being processed according to the selected wireless protocol. In some examples, the method 600 may further include causing the wireless, RF transmission using a TeraHertz frequency channel.

The method 600 may further include providing output data based on the input data being mixed using set of weight values, the output data representative of the wireless, RF transmission to the semiconductor chip being processed according to the selected wireless protocol, at 660.

The steps included in the described example method 600 are for illustration purposes. In some embodiments, the steps may be performed in a different order. In some other embodiments, various steps may be eliminated. In still other embodiments, various steps may be divided into additional steps, supplemented with other steps, or combined together into fewer steps. Other variations of these specific steps are contemplated, including changes in the order of the steps, changes in the content of the steps being split or combined into other steps, etc.

From the foregoing it will be appreciated that, although specific embodiments of the invention have been described herein for purposes of illustration, various modifications may be made without deviating from the spirit and scope of the invention.

What is claimed is:

1. A system comprising:
at least one processing unit; and
non-transitory computer readable media encoded with executable instructions which, when executed by the at least one processing unit, is configured to cause the system to:
receive input data for a wireless, radio frequency (RF) transmission;
receive selection of a wireless protocol of a plurality of wireless protocols to be utilized in the wireless, RF transmission to a semiconductor chip;
based on the selected wireless protocol, select a set of weight values from a plurality of sets of weight values;
mix the input data using the selected set of weight values; and
provide output data based on the input data being mixed using set of weight values, the output data representative of the wireless, RF transmission to the semiconductor chip being processed according to the selected wireless protocol.

2. The system of claim 1, wherein the instructions, when executed by the at least one processing unit, are further configured to cause the system to:
select a first set of weight values from the plurality of sets of weight values as the selected set of weight values in response to the wireless protocol being a first wireless protocol; and
select a second set of weight values from the plurality of sets of weight values as the selected set of weight values in response to the wireless protocol being a second wireless protocol.

3. The system of claim 2, wherein the first wireless protocol is for intra-device communications and the second wireless protocol is for inter-device communications.

4. The system of claim 1, wherein the instructions, when executed by the at least one processing unit, are further configured to cause the system to cause the wireless, RF transmission using a TeraHertz frequency channel.

5. The system of claim 1, wherein the semiconductor chip and the at least one processing unit are both included in a single semiconductor device.

6. The system of claim 5, wherein the semiconductor chip and the at least one processing unit are both included in different semiconductor device.

7. The system of claim 1, wherein the selected wireless protocol includes a modulation mapping that corresponds to at least one of GFDM, FBMC, UFMC, DFDM, SCMA, NOMA, MUSA, or FTN.

8. The system of claim 1, wherein the instructions, when executed by the at least one processing unit, are further configured to cause the system to:
multiply a portion of the input data with one of the set of weight values to generate a weight multiplication result; and
accumulate the weight multiplication result to be further multiplied and accumulated with other portions of the input data and additional weight values of the set of weights values to mix the input data with the set of weight values.

9. An apparatus comprising:
a device having a first semiconductor chip and a second semiconductor chip, wherein the first semiconductor chip has a configurable baseband processor that is configured to mix input data with a first set of weight values corresponding to a first wireless protocol to be utilized in a wireless, RF transmission to the second semiconductor chip when the input data is a first type of data and to mix the input data with a second set of weight values corresponding to a second wireless protocol to be utilized in the wireless, RF transmission to the second semiconductor chip when the input data is a second type of data.

10. The apparatus of claim 9, further comprising a second device having a third semiconductor chip; wherein the configurable baseband processor of the first semiconductor chip is further configured to mix the input data with a third set of weight values corresponding to a third wireless protocol to be utilized in a wireless, RF transmission to the third semiconductor chip when the input data is a third type of data.

11. The apparatus of claim 10, wherein the first semiconductor chip includes a processor core and the third semiconductor chip includes a memory controller.

12. The apparatus of claim 9, wherein the first semiconductor chip includes a first processor core and the second semiconductor chip includes a second processor core.

13. The apparatus of claim 9, wherein the configurable baseband processor is configured to cause the wireless, RF transmission to the second semiconductor chip using a TeraHertz frequency channel.

14. The apparatus of claim 9, wherein the first wireless protocol includes a modulation mapping that corresponds to at least one of GFDM, FBMC, UFMC, DFDM, SCMA, NOMA, MUSA, or FTN, and the second wireless protocol includes a modulation mapping that corresponds to a different one of the at least one of GFDM, FBMC, UFMC, DFDM, SCMA, NOMA, MUSA, or FTN.

15. A method comprising:
receiving, at a baseband processor of a first semiconductor chip, input data for a wireless, radio frequency (RF) transmission;
receiving, at the baseband processor, selection of a wireless protocol of a plurality of wireless protocols to be utilized in the wireless, RF transmission to a second semiconductor chip;
based on the selected wireless protocol, selecting a set of weight values from a plurality of sets of weight values;
mixing the input data using the selected set of weight values; and
providing output data based on the input data being mixed using set of weight values, the output data representative of the wireless, RF transmission to the semiconductor chip being processed according to the selected wireless protocol.

16. The method of claim 15, further comprising:
selecting a first set of weight values from the plurality of sets of weight values as the selected set of weight values in response to the wireless protocol being a first wireless protocol; and
selecting a second set of weight values from the plurality of sets of weight values as the selected set of weight values in response to the wireless protocol being a second wireless protocol.

17. The method of claim 16, wherein the first wireless protocol is for intra-device communications and the second wireless protocol is for inter-device communications.

18. The method of claim 15, further comprising causing the wireless, RF transmission using a TeraHertz frequency channel.

19. The method of claim 15, wherein the first semiconductor chip and the second semiconductor chip are both included in a single semiconductor device.

20. The method of claim 15, wherein the semiconductor chip and the second semiconductor chip are both included different semiconductor devices.
